(19) United States
(12) Patent Application Publication
(10) Pub. No.: US 2025/0297870 A1
(43) Pub. Date: Sep. 25, 2025

(54) CAPACITIVE MICROSENSOR WITH COMPENSATION ELECTRODE

(71) Applicant: Robert Bosch GmbH, Stuttgart (DE)

(72) Inventors: Arne Dannenberg, Metzingen (DE); Bernhard Maier, Stuttgart (DE); Alexander Schoenhals, Suzhou Jiangsu (CN)

(21) Appl. No.: 19/085,057

(22) Filed: Mar. 20, 2025

(30) Foreign Application Priority Data
Mar. 22, 2024 (DE) 10 2024 202 756.1

(51) Int. Cl. G01D 5/241

(52) U.S. Cl. CPC G01D 5/241

(57) ABSTRACT

A capacitive microsensor. The capacitive microsensor includes a sensor element having an electrical terminating circuit that provides an input voltage formed between an electrical first input potential and an electrical second input potential and taps at least one electrical first output potential and includes at least one electrical first terminal region facing a sensor environment, further having at least one first capacitance formed by a first electrode facing the sensor environment of the sensor element and a first counter electrode electrically integrated in the terminating circuit, a stray capacitance effective over the sensor environment being formed and at least one first compensation electrode being arranged between the first terminal region and the first electrode, which, together with the first terminal region, forms a compensation capacitance effective over the sensor environment and which is electrically connected to the stray capacitance via the terminating circuit for compensating the stray capacitance.

### FIELD

The present invention relates to a capacitive microsensor.

### BACKGROUND INFORMATION

German Patent Application No. DE 10 2020 214 757 A1 describes a capacitive pressure sensor comprising a membrane that adjoins a gas-tight internal volume within a housing component of the pressure sensor. The membrane can deform if there is a pressure difference between the internal pressure and the external pressure. A measuring electrode is attached to the membrane, the position of which changes due to the warping of the membrane. This change in position leads to a change in the measuring capacitance, which consists of the measuring electrode and an associated measuring counter electrode. In addition, the sensor comprises at least one constant reference capacitance having two reference electrodes that are fixedly fastened to the housing component and whose position does not change due to the warping of the membrane.

### SUMMARY

According to the present invention, a capacitive microsensor is provided. According to an example embodiment of the present invention, the capacitive microsensor includes: a sensor element having an electrical terminating circuit that provides an input voltage formed between an electrical first input potential and an electrical second input potential and taps at least one electrical first output potential and include at least one electrical first terminal region facing a sensor environment, further having at least one first capacitance formed by a first electrode facing the sensor environment of the sensor element and a first counter electrode electrically integrated in the terminating circuit; wherein a stray capacitance effective over the sensor environment is formed and at least one first compensation electrode is arranged between the first terminal region and the first electrode, which compensation electrode, together with the first terminal region, forms a compensation capacitance effective at least over the sensor environment and which is electrically connected to the stray capacitance via the terminating circuit for compensating the stray capacitance.

As a result, the stray capacitance can be compensated and the microsensor can be more robust to environmental influences. The microsensor can be operated more accurately and reliably.

The microsensor can be a microelectromechanical sensor. The microsensor can be a humidity sensor, gas sensor or pressure sensor. The pressure sensor can be an absolute pressure sensor, in particular a barometric pressure sensor, or a differential pressure sensor.

The microsensor can measure at least one environmental variable. The environmental variable can be a fluid pressure, in particular a water pressure and/or air pressure, of the sensor environment. The environmental variable can be a sound pressure, which makes the microsensor effective as a microphone.

The sensor environment can usually be in the form of air.

According to an example embodiment of the present invention, the first capacitance can vary according to the environmental variable. The microsensor can comprise a membrane that at least partially spans a cavity. The membrane can be deflected according to the environmental variable. The first counter electrode can be arranged in the cavity.

The sensor element can comprise a substrate. The first electrode and/or first counter electrode can be electrically connected within the substrate. The cavity can be arranged in the substrate.

The first electrode can be connected to the membrane in a deflectable manner. The first capacitance can vary according to the deflection of the membrane. The membrane can be designed separately from the first electrode. The membrane can be designed integrally with the first electrode.

According to an example embodiment of the present invention, the microsensor can comprise at least a first reference capacitance having at least a first reference electrode and a first reference counter electrode. The first reference capacity can be constant with respect to the environmental variable. The first reference capacitance can be arranged in the cavity. The first reference electrode and the first reference counter electrode can be fixed relative to the substrate.

The first terminal region can be formed by a bond pad and/or a conductor track. The first terminal region can be arranged on the surface of the substrate of the sensor element.

The stray capacitance and the compensation capacitance can vary according to environmental influences, in particular an accumulation or deposition of foreign material, in particular water, on the surface of the sensor element. The stray capacitance and the compensation capacitance can vary according to a dielectric constant of the sensor environment above the sensor element.

The first compensation electrode can be designed integrally with a further terminal region of the terminating circuit. For this purpose, the additional terminal region can be enlarged.

In a preferred example embodiment of the present invention, it is advantageous if the first compensation electrode is arranged on a side of the sensor element facing the sensor environment. The first compensation electrode can be arranged on the surface of the substrate.

In a specific example embodiment of the present invention, it is advantageous if the stray capacitance and the compensation capacitance are electrically connected in series. The stray capacitance can be electrically effective parallel to the first capacitance. The compensation capacitance can be electrically connected in parallel with the first reference capacitance.

The compensation of the first stray capacitance via the compensation capacitance can be done passively, i.e. solely by the electrical connection of the stray capacitance and the compensation capacitance. Active compensation may be unnecessary.

In a specific example embodiment of the present invention, it is advantageous if the first terminal region comprises the first input potential, the second input potential or the first output potential. The first terminal region can also comprise a second output potential.

In a specific example embodiment of the present invention, it is advantageous if the first compensation electrode comprises the first input potential, the second input potential or the first output potential.

In a specific example embodiment of the present invention, it is advantageous if the electrical potential of the first compensation electrode is different from the electrical potential of the first electrode. As a result, the stray capacitance can be easily compensated by electrical connection to the compensation capacitance in the terminating circuit.

In a preferred example embodiment of the present invention, it is advantageous if the first compensation electrode is arranged spatially between the first terminal region and the first electrode. The first compensation electrode can be spatially arranged between the first terminal region and a further terminal region of the terminating circuit. The first compensation electrode can be spatially arranged between the further terminal region and the first electrode.

In a specific example embodiment of the present invention, it is advantageous if the terminating circuit comprises a second terminal region facing the sensor environment, a second compensation electrode, in addition to the first compensation electrode, being arranged at a distance from the first compensation electrode, which second compensation electrode forms a further compensation capacitance effective over the sensor environment and which is electrically connected to the stray capacitance and/or the further stray capacitance via the terminating circuit for compensating the stray capacitance and/or a further stray capacitance of the sensor element. The first and/or second compensation electrode can be arranged between the first and second terminal regions. The first and/or second compensation electrode can be spatially arranged between the first and second terminal region and the first electrode.

The second terminal region can be formed by a bond pad and/or a conductor track. The second terminal region can comprise an electrical potential different from the first terminal region.

The second compensation electrode can comprise an electrical potential different from the first compensation electrode.

In a preferred embodiment of the present invention, it is advantageous if the first terminal region is covered by a protective material. The protective material can isolate the first terminal region from the sensor environment. The protective material can comprise silicon nitride. The protective material can be a gel, in particular free of per- and polyfluorinated alkyl substances, preferably a silicone gel or a polymer-containing material, in particular parylene.

The protective material can form the surface of the sensor element toward the sensor environment, at least in portions. The protective material can be applied to a substrate surface of the substrate.

A preferred embodiment of the present invention is advantageous in which a maximum material thickness of the protective material, at least in the region between the first terminal region and including the first electrode, is less than 50 μm, in particular less than 25 μm. The maximum material thickness can be greater than 4 μm. As a result, the sensitivity of the microsensor can be increased.

Further advantages and advantageous example embodiments of the present invention can be found in the description of the figures and in the figures.

### DETAILED DESCRIPTION OF EXAMPLE EMBODIMENTS

The present invention is described in detail below with reference to the drawing figures.

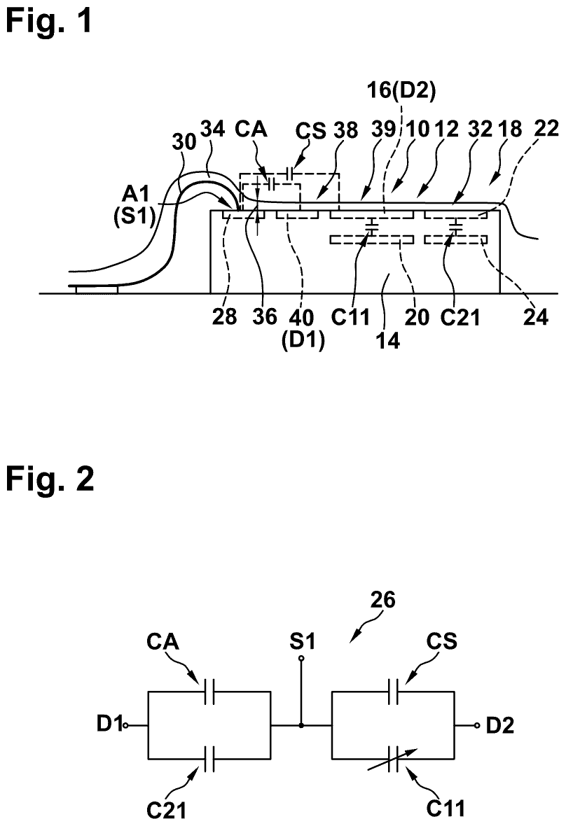

FIG. 1 is a side view of a microsensor in a specific embodiment of the present invention.

FIG. 2 shows a terminating circuit of the microsensor from FIG. 1.

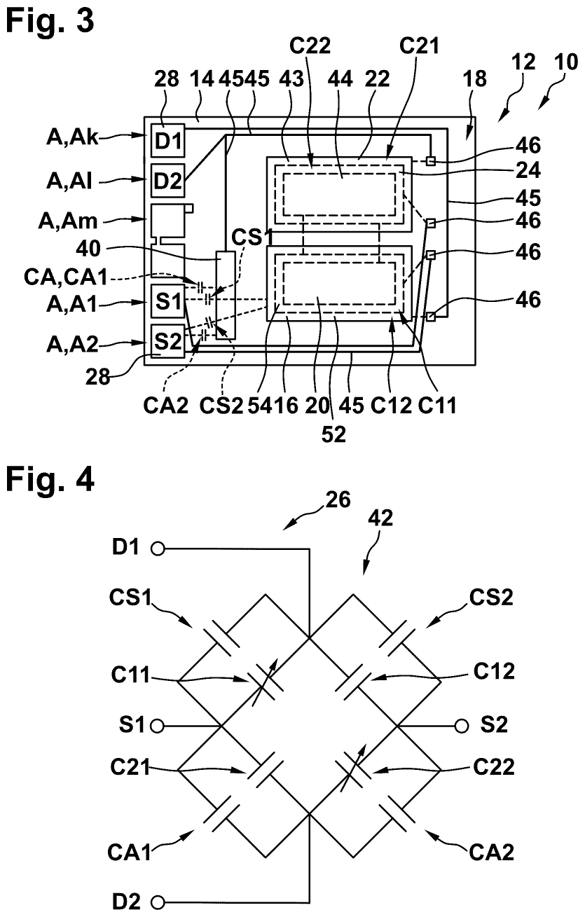

FIG. 3 is a plan view of a microsensor in a further special embodiment of the present invention.

FIG. 4 shows a terminating circuit of the microsensor from FIG. 3, according to an example embodiment of the present invention.

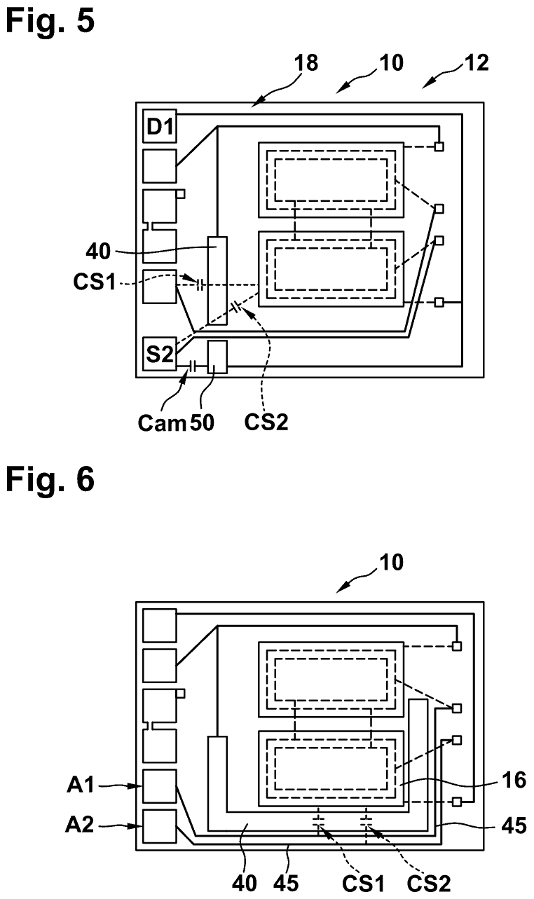

FIGS. 5 and 6 is a plan view of a microsensor in a particular further specific embodiment of the present invention.

### DETAILED DESCRIPTION OF EXAMPLE EMBODIMENTS

FIG. 1 is a side view of a microsensor in a specific embodiment of the present invention. The capacitive microsensor 10 comprises a sensor element 12 having a substrate 14 and therein a first capacitance C11 formed by a first electrode 16 facing a sensor environment 18 of the sensor element 12 and a first counter electrode 20. Furthermore, the sensor element 12 comprises a first reference capacitance C21 having a first reference electrode 22 and a first reference counter electrode 24.

The microsensor 10 can, for example, be a pressure sensor in which the first capacitance C11 is variable according to an environmental variable of the sensor environment 18, for example an air pressure of the sensor environment 18. For example, the first electrode 16 can be movable, in particular deflectable, relative to the first counter electrode 20 according to the environmental variable and can thereby change the first capacitance C11 according to a distance between the first electrode 16 and the first counter electrode 20. The first reference capacitance C21, on the other hand, can remain constant regardless of the environmental variable.

The first capacitance C11 and the first reference capacitance C21 are integrated in an electrical terminating circuit 26 shown in FIG. 2, which provides an input voltage formed between an electrical first input potential D1 and an electrical second input potential D2 to the sensor element and taps at least one electrical first output potential S1 of the sensor element. The first capacitance C11 and the first reference capacitance C21 are electrically connected in series in the terminating circuit 26.

As shown in FIG. 1, the terminating circuit comprises at least one electrical first terminal region A1 facing the sensor environment 18. The first terminal region A1 is formed in particular by a bond pad 28 to which a bond wire 30 is mechanically and electrically connected. The bond wire 30 and a surface 32 of the substrate 14, including the first terminal region A1 and the first electrode 16, are covered with a protective material 34, which preferably comprises a maximum material thickness 36 of less than 50 μm, in particular less than 25 μm, at least in the region 38 between the first terminal region A1 and including the first electrode 16.

Between the first electrode 16 and the first terminal region A1, at least one stray capacitance CS effective over the sensor environment 18 is formed. If a foreign material, for example water, gets on the surface 39 of the sensor element 12, the associated change in the dielectric constant of the sensor environment 18 can lead to a change in the stray capacitance CS, which in turn can have a detrimental effect on the measurement accuracy and sensitivity of the microsensor 10.

However, the microsensor 10 comprises a first compensation electrode 40 on a side of the sensor element 12 facing the sensor environment 18, which first compensation electrode, together with the first terminal region A1, forms at least one compensation capacitance CA effective over the sensor environment 18 and which is electrically connected to the stray capacitance CS via the terminating circuit for compensating the stray capacitance CS.

As shown in FIG. 2, the input voltage is applied via the first capacitance C11 and the first reference capacitance C21, which are electrically connected in series. The first output potential S1 is tapped between the first capacitance C11 and the first reference capacitance C21. The stray capacitance CS is electrically effective in parallel with the first capacitance C11. The compensation capacitance CA is electrically connected in parallel to the first reference capacitance C21. For example, the first output potential S1 is applied to the first terminal region A1 in FIG. 1. The first input potential D1 is applied to the first compensation electrode 40 and the second input potential D2 is applied to the first electrode 16. The stray capacitance CS and the compensation capacitance CA are electrically connected in series.

FIG. 3 is a plan view of a microsensor in a further special embodiment of the present invention. In addition to the first capacitance C11 and the first reference capacitance C21, the microsensor 10 has, in the sensor element 12, a second capacitance C22 and a second reference capacitance C12, which preferably, like the first capacitance C11, can be varied according to the environmental variable. As shown in FIG. 4, the first capacitance C11, the first reference capacitance C21, the second capacitance C22 and the second reference capacitance C12 are electrically connected in a measuring bridge 42 through the terminating circuit 26. The input voltage formed between the first input potential D1 and the second input potential D2 is applied via the first capacitance C11 and first reference capacitance C21 connected electrically in series and the second capacitance C22 and second reference capacitance C12 connected electrically in series. The first capacitance C11 and the first reference capacitance C21 are electrically connected in parallel to the second capacitance C22 and the second reference capacitance C12. The first output potential S1 is tapped between the first capacitance C11 and the first reference capacitance C21 and a second output potential S2 is tapped between the second capacitance C22 and the second reference capacitance C12.

As shown in FIG. 3, the terminating circuit comprises a plurality of terminal regions A, for example the first terminal region A1 to which the first output potential S1 is applied, a second terminal region A2 to which the second output potential S2 is applied, a further terminal region Ak to which the first input potential D1 is applied, a further terminal region A1 to which the second input potential D2 is applied, and a further terminal region Am that is grounded.

The terminal regions A are each formed by a bond pad 28. The first electrode 16 of the first capacitance C11 and a second electrode 43 of the second capacitance C22 face the sensor environment 18. The first counter electrode 20 is arranged below the first electrode 16 and facing away from the sensor environment 18 and is electrically connected to the first output potential S1. A second counter electrode 44 of the second capacitor C22 is arranged below the second electrode 43 and facing away from the sensor environment 18 and is electrically connected to the second output potential S2. The first reference electrode 22 is electrically connected to the second electrode 43. The first reference counter electrode 24 is electrically connected to the first output potential S1. A second reference electrode 52 of the second reference capacitance C12 is electrically connected to the first input potential D1 and a second reference counter electrode 54 of the second reference capacitance C12 is electrically connected to the second output potential S2. The first electrode 16 forms the first capacitance C11 with the first counter electrode 20 and the second reference capacitance C12 with the second reference counter electrode 54. The second electrode 42 forms the second capacitance C22 with the second counter electrode 44 and the first reference capacitance C21 with the first reference counter electrode 24.

The electrical contact between the terminal regions A and the electrodes is made via surface-routed conductor tracks 45, which, on a side opposite the terminal regions A, are connected to contact pads 46, which electrically connect the electrodes structured within the substrate 14 to the conductor tracks 45.

A first stray capacitance CS1 across the sensor environment 18 is formed between the first terminal region A1 comprising the first output potential S1 and the first electrode 16. A second stray capacitance CS2 is formed between the second terminal region A2 comprising the second output potential S2 and the first electrode 16. As shown in FIG. 4, the first stray capacitance CS1 is electrically effective parallel to the first capacitance C11 and the second stray capacitance CS2 is electrically effective parallel to the second reference capacitance C12.

As shown in FIG. 3, a first compensation electrode 40 is spatially arranged between the first and second terminal regions A1, A2 on the one hand and the first electrode 16 on the other hand. As a result, the compensation capacitance CA is formed as a first compensation capacitance CA1 between the first terminal region A1 and the first electrode 16, and a second compensation capacitance CA2 is formed between the second terminal region A2 and the first electrode 16. The first compensation electrode 40 is electrically connected to the second input potential D2. As a result, as shown in FIG. 4, the first compensation capacitance CA1 is electrically connected in parallel with the first reference capacitance C21 and the second compensation capacitance CA2 is electrically connected in parallel with the second capacitance C22. As a result, the first and second stray capacitances CS1, CS2 can be compensated by the first and second compensation capacitances CA1, CA2.

FIGS. 5 and 6 are plan views of a microsensor in a particular further specific embodiment of the present invention. The microsensor 10 in FIG. 5 is similar to that in FIG. 3 except for the following differences. In addition to the first compensation electrode 40, a second compensation electrode 50 is arranged at a distance from the first compensation electrode 40, which, together with the second terminal region A2, forms a further compensation capacitance CAm effective over the sensor environment 18. The second compensation electrode 50 is electrically connected to the first input potential D1.

The second compensation electrode 50 is electrically connected to the first stray capacitance CS1 and the further stray capacitance CS2 via the terminating circuit for compensating the first stray capacitance CS1 and/or the second stray capacitance CS2 of the sensor element 12.

The microsensor 10 in FIG. 6 is similar to that in FIG. 3 except for the following differences. The first compensation electrode 40 is enlarged and also compensates for the first stray capacitance CS1 extending between the conductor track 45, which is electrically connected to the first terminal region A1, and the first electrode 16, and for the second stray capacitance CS2 extending between the conductor track 45, which is electrically connected to the second terminal region A2, and the first electrode 16.

1-10. (canceled)

11. A capacitive microsensor, comprising
a sensor element including an electrical terminating circuit that provides an input voltage formed between an electrical first input potential and an electrical second input potential, and taps at least one electrical first output potential, and includes at least one electrical first terminal region facing a sensor environment, and further includes at least one first capacitance formed by a first electrode facing the sensor environment of the sensor element and a first counter electrode electrically integrated in the terminating circuit;
wherein a stray capacitance effective over the sensor environment is formed and at least one first compensation electrode is arranged between the first terminal region and the first electrode, the compensation electrode, together with the first terminal region, forms a compensation capacitance effective at least over the sensor environment and which is electrically connected to the stray capacitance via the terminating circuit for compensating the stray capacitance.

12. The capacitive microsensor according to claim 11, wherein the first compensation electrode is arranged on a side of the sensor element facing the sensor environment.

13. The capacitive microsensor according to claim 11, wherein the stray capacitance and the compensation capacitance are electrically connected in series.

14. The capacitive microsensor according to claim 11, wherein the first terminal region includes the first input potential or the second input potential or the first output potential.

15. The capacitive microsensor according to claim 11, wherein the first compensation electrode includes the first input potential or the second input potential or the first output potential.

16. The capacitive microsensor according to claim 11, wherein an electrical potential of the first compensation electrode is different from an electrical potential of the first electrode.

17. The capacitive microsensor according to claim 11, wherein the first compensation electrode is arranged spatially between the first terminal region and the first electrode.

18. The capacitive microsensor according to claim 11, wherein the terminating circuit includes a second terminal region facing the sensor environment, a second compensation electrode being arranged at a distance from the first compensation electrode, the second compensation electrode forming a further compensation capacitance effective over the sensor environment and which is electrically connected via the terminating circuit to: (i) the stray capacitance and/or (ii) the further stray capacitance, for compensating the stray capacitance and/or a further stray capacitance of the sensor element.

19. The capacitive microsensor according to claim 11, wherein the first terminal region is covered by a protective material.

20. The capacitive microsensor according to claim 19, wherein a maximum material thickness of the protective material, at least in the region between the first terminal region and including the first electrode, is less than 50 μm and greater than 4 μm.
